(19) United States
(12) Patent Application Publication
(10) Pub. No.: US 2010/0084431 A1
(43) Pub. Date: Apr. 8, 2010

(54) Self-Heating Material Dispenser

(75) Inventors: Richard A. Miller, White Bear Lake, MN (US); Stephen G. Rippe, White Bear Lake, MN (US); Timothy W. Roska, Forest Lake, MN (US); Steven A. Jorissen, Vadnais Heights, MN (US); Gregory W. Schad, Cary, IL (US)

Correspondence Address: H.B. FULLER COMPANY;Patent Department, 1200 WILLOW LAKE BLVD., P.O. BOX 64683, ST. PAUL, MN, 55164-0683, US

(73) Assignee: H.B. Fuller Company, St. Paul, MN (US)

(21) Appl. No.: 12/566,313

(22) Filed: Sep. 24, 2009

Related U.S. Application Data
(60) Provisional application No. 61/102,705, filed on Oct. 3, 2008.

(51) Int. Cl. B67D 7/82; F24J 1/00; B67D 7/00

(52) U.S. Cl. 222/146.2; 222/1; 126/263.01; 222/94; 222/130; 222/326

(57) ABSTRACT

A dispensing unit, which utilizes a chemical reaction or phase transition to soften a material into a flowable state, is described. The material comprises an adhesive, sealant or caulk.

### BACKGROUND

This invention relates to dispensing unit, which utilizes heat generated by an exothermic chemical reaction or a phase transition to soften a material into a flowable state. The material comprises an adhesive, sealant or caulk.

A hot melt adhesive is a solid at room temperature. In order to form a bond the adhesive is heated to a temperature that enables the adhesive to become molten and flow. The molten adhesive is then applied to one substrate, with an applicator of some kind, and a second substrate is pushed into place. As the adhesive cools, a bond is formed.

In a home setting, a consumer can apply a hot melt adhesive with an electric glue gun using a hot melt glue stick. A cylindrical glue stick formed of hot melt adhesive is inserted into one end of the gun, advanced through a heating element, and dispensed in a molten state at the end of the applicator, generally in a bead form. In a home setting, a hot melt adhesive can also be applied using a hot melt glue skillet. A hot melt glue skillet is a small electric pan open to the air in which adhesive is melted. Parts are dipped directly into the skillet and then bonded to a second substrate.

The equipment available to form a hot melt adhesive bond in a home setting works fairly well but is limited in that a source of electricity is needed in order to melt the adhesive. The use of hot melt adhesives by a consumer is further limited, as it is not possible to use reactive hot melts as glue sticks or in a hot melt skillet. Reactive hot melts can be melted and applied as a hot melt but, then cure from moisture in the air to form a bond that has improved strength, cold and warm temperature resistance and improved adhesion to a wider variety of substrates. Reactive hot melts in a stick form or in pellets would begin to cure prior to use and would not re-melt.

Sealants and caulks are important consumer and construction compounds; they are used to fill gaps or joints between two or more similar or dissimilar surfaces or contours. Construction occurs year round and when it is necessary to use a caulk outside in cold weather, either at a construction site or for home use, it can be very difficult to pump the caulk out of the tube. Construction sites often have hot boxes where the caulk is heated periodically so it continues to flow.

It would be desirable if a self-heating material dispenser existed that could melt and apply a material without using electricity. It would further be desirable if such a dispenser could dispense any material selected from a group consisting of hot melt adhesive, reactive adhesive, sealant and caulk.

### SUMMARY

The self-heating material dispenser of this invention encompasses any dispenser or container that includes and relies on either an exothermic reaction or a phase change to provide the heat necessary to dispense an adhesive, sealant, or caulk.

In one embodiment, the material dispenser comprises: a first chamber containing the material to be softened; a second chamber, adjacent to the first chamber, containing at least one heat-generating component; an application means in fluid communication with the first chamber, said means being configured to allow material to flow from the first chamber, through said means and optionally, a separate manually operable apparatus to aid in dispensing the heated material on demand.

In one embodiment, the heat-generating component comprises iron.

In one embodiment, the exothermic chemical reaction is initiated upon exposure to oxygen.

In one embodiment, the second chamber contains a first compartment holding a first heat-generating component and a second compartment holding a second heat-generating component, the first and second compartments being separated in at least one area by a flexible barrier. In one embodiment, blending the first-heat generating component and the second heat generating component results in an exothermic chemical reaction. In one embodiment, one heat-generating component comprises iron and the second heat-generating component comprises sodium chloride and water.

In one embodiment, the material dispenser contains a movable reaction actuator to rupture the flexible barrier.

In one embodiment, the second chamber is located within the material to be softened.

In one embodiment, the material to be softened is a reactive hot melt adhesive that has a viscosity of <about 10,000 cps at 149° C.

In one embodiment, the dispenser is disposable. In other embodiments, the first chamber and the second chamber are supplied separately and assembled just prior to use.

In one embodiment at least two different materials are dispensed simultaneously.

In another embodiment the material is heated on demand.

In one embodiment, the material dispensed is selected from a group consisting of a hot melt adhesive, a reactive hot melt adhesive, and a two-component reactive adhesive. In still other embodiments, the material dispensed is selected from a group consisting of a sealant and a caulk.

In one embodiment a method of dispensing a material comprising:

providing a dispenser comprising at least one non-electric heat-generating component in heat transfer communication with the material; activating the said heat-generating component;
allowing enough heat to be generated to render the material flowable and dispensing the material from the dispenser is disclosed.

In one embodiment a method of dispensing a material comprising: providing a dispenser comprising at least one non-electric heat-generating component in heat transfer communication with the material; activating the said heat-generating component; allowing enough heat to be generated to render the material flowable and dispensing the material from the dispenser onto any portion of a pipeline, a storage tank or an insulation composite is disclosed.

### BRIEF DESCRIPTION OF THE DRAWINGS

FIG. 1A is an outside view of one embodiment of the one part material dispenser.

FIG. 1B is an interior view of one embodiment of a combination cap and barrier breaking means.

FIG. 1C is a vertical cross-sectional view of FIG. 1A.

FIG. 2 is a side view of one embodiment of a dispensing apparatus where the material dispenser comprises two parts.

FIG. 3 is a side view of one embodiment of a cartridge where the material dispenser comprises two parts.

FIGS. 4 AND 5 are views of two mechanical means for rupturing the barrier that separates the two compartments within the second chamber.

FIG. 6A is an outside view of one embodiment of a dispensing apparatus where the second chamber has one compartment.

FIG. 6B is a cross-sectional view of the second end of FIG. 6A with seal removed.

FIG. 6C is a cross-sectional view of the second end of FIG. 6A with seal intact.

FIG. 7 is an interior view of one embodiment where the material is softened or melted on demand.

### DETAILED DESCRIPTION

The material dispenser of this invention may comprise one part or alternately, two parts.

### I. One Part

A. Cartridge

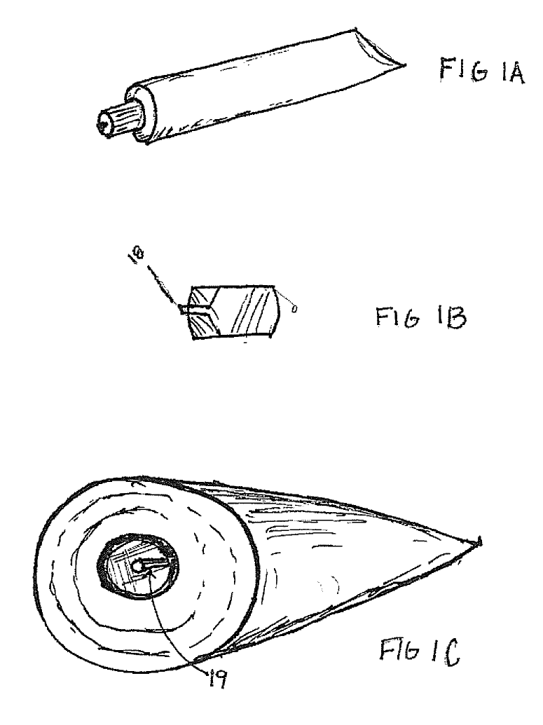

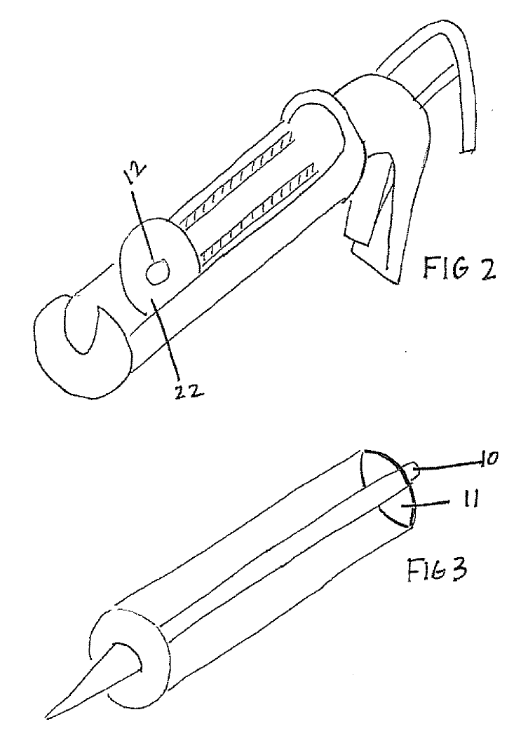

In one embodiment, the dispenser comprises one part. The one part comprises a cartridge. In one embodiment, the one part dispenser may comprise a flexible tube as in FIG. 1A. In the FIG. IA embodiment, the cartridge is shaped like toothpaste tube and the material once softened is squeezed out of the tube. In one embodiment, the tube contains less than or equal to around 2 pounds (908 grams), more preferred less than or equal to around 1 pound (454 grams), or most preferred less than or equal to around 8 ounces (113 grams) of material to be softened. The tube may collapse as the material is dispensed. In one embodiment, the tube contains a key at the second end to assist in winding up the tube thus pushing the material out the first end. The tube may be formed of a flexible metal such as aluminum; alternatively the tube may be formed from fiberboard, paperboard, foil lined fiber/paperboard, craft backed aluminum foil, high-density polyethylene, low-density polyethylene, polypropylene, polystyrene or polyvinylchloride. In one embodiment, the tube comprises a lamination including aluminum, fiberboard, high-density polyethylene, polypropylene or polyvinylchloride.

In one embodiment, the first end of the cartridge contains a cap to protect the cartridge during shipping. The first end also contains the means for applying the material. In one embodiment, the means is a nozzle or a multi bead nozzle. In alternate embodiments, the means may be, for example, a slot die, multi slot pattern die, extrusion tip, a screw-in tip or a European nub type nozzle. The cartridge may have an insulating outer layer to prevent the outside of the tube from getting too hot for the consumer to handle. In one embodiment, the insulating outer layer comprises a foamed polymer. In one embodiment, the cartridge is intended for a single use. The one part embodiment is particularly useful when only one use is anticipated e.g. for crafts, part of a craft kit, or part of an outdoor repair kit. The cartridge is made up of two chambers that are separated from each other.

1. First Chamber

The first chamber comprises the material to be softened. Although, the first chamber will often comprise one continuous space, it is envisioned that it could be divided into two compartments if the material to be softened comprises two components. It is anticipated that the dispenser of the present invention can be used to dispense a number of different materials.

The material to be softened could be a thermoplastic or a thermoset. A thermoplastic material is made fluid with heat and then becomes solid as it cools. A thermoplastic can be re-melted. A thermoset material is kept in a sealed container until ready to use. It may be made fluid with heat or alternately applied at room temperature. Once, released from the sealed container, a thermoset cures to form a material that cannot be re-melted.

In one embodiment, the material to be softened is a thermoplastic hot melt adhesive. In this embodiment, it is useful that the adhesive have a viscosity of <about 10,000 cps @ 177° C. (350° F.), more preferably <about 10,000 cps @ 149° C. (300° F.), or even <about 10,000 cps @ 121° C. (250° F.).

The hot melt adhesive for use with the dispenser of this invention may vary widely in terms of both composition and properties. For example, the hot melt may comprise polyamide, polyester, polyethylene, ethylene copolymer (e.g. ethylene vinyl-acetate or ethylene-octene), styrene block copolymers or APAO (amorphous poly-alpha olefins). It may alternately comprise any other thermoplastic polymer. It may further comprise additional hot melt components, including but not limited to resin, wax, oil, liquid plasticizers of any sort, solid plasticizers of any sort, fillers, pigments and antioxidants.

In another embodiment, the material to be softened is a thermosetting reactive hot melt adhesive comprising one or two components. The reactive hot melt adhesive may be based on polyurethane or alternately silane, epoxy, cyanoacrylate or acrylic. In one embodiment, the reactive hot melt adhesive may be a hot melt moisture cure. It is useful that the reactive hot melt adhesive have a viscosity of <about 10,000 cps @ 177° C. (350° F.), or <about 10,000 cps @ 149° C. (300° F.), or even <about 10,000 cps @ 121° C. (250° F.). The higher strength, higher heat resistance and cold temperature properties of reactive hot melts make them well suited for applications such as structural repairs and outdoor patching applications where these properties are desired.

The inventors further envision that the material to be softened could be a heat activated (i.e. heat curable) material comprising one or two components. The material could be based on epoxy or alternately polyester. In either case, the heat generated by the dispenser could be used to improve the ease of applying and/or initiate the curing of the material. One example of such a material is a two-component heat activated epoxy system based on epichlorohydrin and bisphenol A. Compounds such as boron triflouride-amine complexes and powdered dicyandiamide compounds may be used as heat activated curing agents in an epoxy system such as this.

In yet another embodiment, the material to be softened is a sealant or a caulk. In one embodiment, the sealant or caulk comprises filler and polymer. Filler is an inorganic solid that is often used in particulate form. In one embodiment the filler may be calcium carbonate, calcium silicate, barium sulfate, clay, talc, zinc oxide, carbon black or titanium dioxide. In one embodiment, more than one filler is used. In one embodiment, the polymer may be polybutene, butyl rubber, polyisobutylene, chlorosulfonated polyethylene, polychloroprene, styrene-butadiene, nitrile rubber or polyurethane. Alternatively, the sealant or caulk could comprise additional polymers and/or fillers. In some embodiments, the heating enables a caulk or sealant to be applied with greater ease outdoors when it is cold.

2. Second Chamber

The second chamber contains the heating source. The heating source can comprise any composition capable of generating heat by exothermic reaction or phase transition. The heating source does not comprise electricity, a battery or a flame. In a preferred embodiment, the heat generating material comprises a mix of chemical compounds that undergo an oxidation reaction.

### a.) One Compartment Embodiment

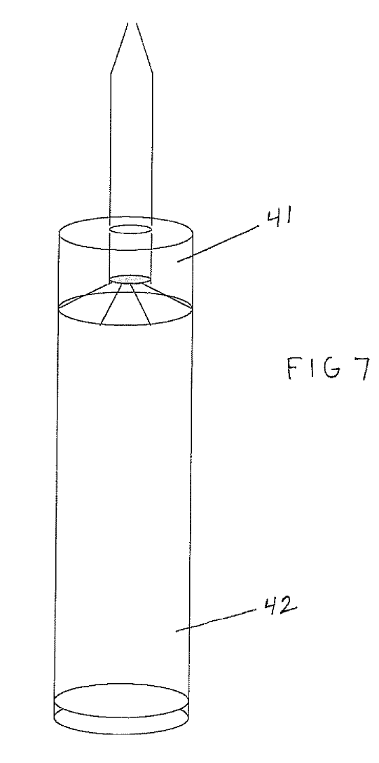

The second chamber may comprise one compartment. In one embodiment, the cartridge is cylindrical and a one compartment second chamber is located within the first chamber (FIG. 6A).

In one embodiment, the heat-generating component comprises a particulate solid. It could alternately be present as granules, pellets or slugs. In one embodiment, the heat-generating component comprises iron. The heat-generating material may further comprise carbon, metal salts and water.

In one embodiment, the heat-generating component is placed within an oxygen permeable layer that is segmented into small pockets to keep the heat-generating component evenly distributed throughout the second chamber. The permeable layer may comprise, for example, a non-woven material or alternately a microporous film. Alternately, the heat-generating component may be free flowing within the second chamber. In one embodiment, at the second end of the second chamber there is a flap (FIG. 6B, 31) that can be peeled away. The flap once peeled exposes the second chamber to oxygen in the air and initiates the oxidation reaction to generate heat. Alternately, the heat-generating compound is activated by exposure to oxygen prior to being placed in the second chamber, and the second chamber is not airtight. For example, the heat-generating compound could be supplied in an airtight wrapper, which is opened just prior to use. In this embodiment, the heat-generating compound can easily be disposed and replaced. In one embodiment, there is a screen (FIG. 6C, 32) that allows air to enter yet keeps the heat-generating component in place. This screen may be removable to allow the heat-generating compound to be replaced.

In an alternate one-compartment embodiment, the cartridge is elongated, such as a cylinder and the second chamber surrounds the first chamber. In this embodiment, the heat-generating component may be placed within an oxygen permeable layer as described above and wrapped around the first chamber. In this embodiment, an oxygen impermeable layer is wrapped around the outer surface of the second chamber. The oxygen impermeable layer, or portion thereof, is removed prior to use to expose the second chamber to the atmosphere and initiate the oxidation reaction to generate heat. Controlling the surface area of the heat-generating component exposed to oxygen can control the amount of heat generated. In this embodiment, the second chamber could be supplied separately from the cartridge and inserted or wrapped into place just prior to use. This would enable the consumer to use the same cartridge multiple times.

In an alternate one-component embodiment, a phase transfer generates the heat. In an example of this embodiment, the heat-generating component comprises a sodium acetate gel.

In this embodiment, the bending of a metal disk contained within the assembly triggers the gel to crystallize thus generating heat. The heat-generating component could be disposable or reusable such as by removing the crystallized gel and boiling the bag to reverse the phase back to a gel for reuse. This reusable heat-generating source could be configured in a pouch or vessel for easy insertion into an internal second chamber located substantially inside the first chamber and configured to receive the pouch or vessel. Alternatively, the phase transfer heat generating source can be contained in a flexible second chamber pouch that can be wrapped around the first chamber.

### b.) Two Compartment Embodiment

The second chamber may comprise two compartments that are separated from each other by a temporary flexible barrier. Each compartment contains one heat-generating component such that when the flexible barrier is ruptured, the said heat-generating components come in contact with each other, initiating an exothermic chemical reaction that generates heat.

In one embodiment, the exothermic chemical reaction comprises an inorganic oxidation reaction. In one embodiment, the heat-generating components comprise one liquid and one solid. In one embodiment, the solid comprises a magnesium-iron alloy and the liquid comprises sodium chloride and water. The heat generated by the exothermic chemical reaction can be adjusted by adjusting the concentration of sodium chloride. Higher concentrations of sodium chloride lead to higher amounts of generated heat and conversely lower concentrations of sodium chloride lead to lower amounts of generated heat. In still other embodiments, the solid is calcium oxide and the liquid is water.

Additional heat generating components and oxygen permeable barriers are discussed in US 2004/0112366 A1, which is incorporated by reference in its entirety.

3. Optional Flexible Barrier and Movable Reaction Actuator

When the second chamber comprises two compartments a temporary flexible barrier and optionally a movable reaction actuator are present. The temporary flexible barrier may comprise a metal foil, a plastic film or alternatively any other material that can be ruptured or removed.

In some embodiments, the flexible barrier is peelable and comprises a tab. The user pulls the tab to peel back the flexible barrier, allowing the two components to mix. Alternately, the flexible barrier is a similar shape to the second chamber and is located within it. In this configuration, the flexible barrier is commonly referred to as a frangible seal. The user bends the second chamber back and forth to rupture the frangible seal. In these embodiments, a movable reaction actuator is not necessary.

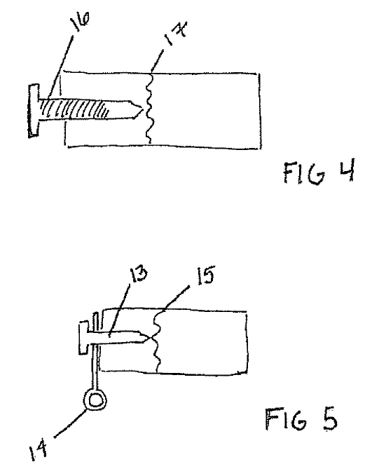

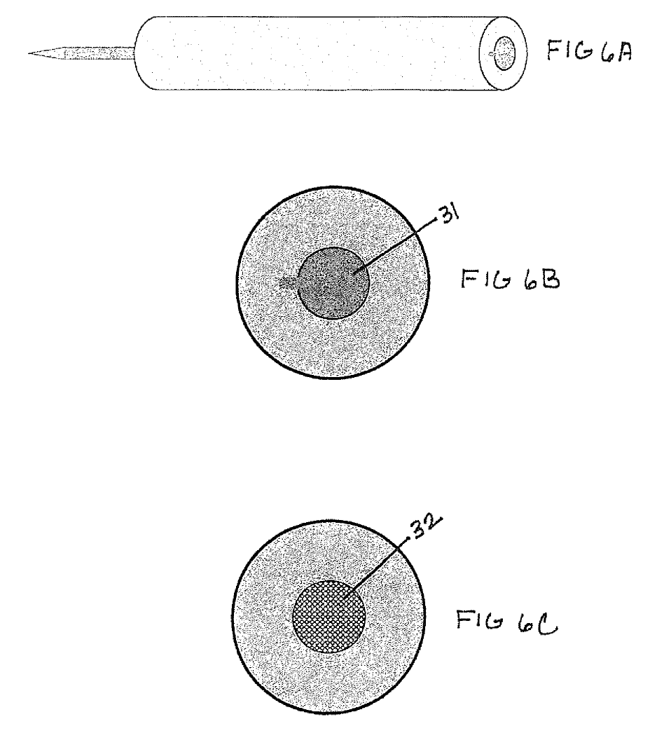

Alternately, a movable reaction actuator ruptures the temporary flexible barrier. The movable reaction actuator may comprise a mechanical means, or an air pressure means. The air pressure means uses air to rupture the flexible barrier. In one embodiment, the air pressure means comprises an air hose and a disposable carbon dioxide cylinder. In one embodiment, (FIG. 1B) the cap is the mechanical means. In this embodiment, when the user is ready to dispense the material, the cap is screwed off, reversed and screwed back on. Within the cap is an extruded rod (FIG. 1B, 18) that locks into a second extruded rod (FIG. 1C, 19) within the second chamber. The motion of screwing the cap on triggers the rupturing of the barrier within the second chamber. In one embodiment the mechanical means is located on the second end of the cartridge. In one embodiment, the mechanical means comprises a screw 16 as illustrated in FIG. 4. The screw pushes through the barrier 17 as it is turned. In another embodiment, the mechanical means comprises a plunger 13 and a pin 14 as illustrated in FIG. 5. The plunger is pushed through the barrier 15 when the pin is removed.

Similar flexible barriers and movable reaction actuator means can be used to allow two components of a reactive adhesive to mix prior to use if the first chamber is divided into two compartments.

### II. Two Part

A. Cartridge

In the two-part embodiment, the dispenser comprises two parts. In many embodiments, the first part comprises a cartridge as described above. The second part comprises an apparatus to push the material from the cartridge. The cartridge is placed within the apparatus and the apparatus used to dispense the material.

In one embodiment, the cartridge of the two-part embodiment is similar in appearance to a tube of caulk (FIG. 3). In one embodiment, the application means is present on a first end and the movable reaction actuator means is present on the second end. The cartridge may further comprise a first advancing member such as a sliding plate (FIG. 3, 11). In one embodiment, the second chamber with the mechanical rupturing means extends out of the center of the first advancing member (FIG. 3, 10) at the said second end of the cartridge. When the material is flowable, the trigger of the dispensing apparatus is engaged, pushing the first advancing member against the material to force the material out of the cartridge.

B. Dispensing Apparatus

In one embodiment, the dispensing apparatus is a standard commercially available caulk gun. In this embodiment, the second chamber is collapsible and deforms as the adhesive is pushed out of the cartridge. In this embodiment, it may be desirable to limit the size of the second chamber to maximize the amount of material in the cartridge.

In one embodiment the apparatus comprises a modified caulk gun by which the material to be softened is pushed out of the cartridge (FIG. 2). In one embodiment, the modified caulk gun may contain a hole 12 in the second advancing member 22 such that as the material is pushed out of the casing the said second advancing member goes around the second chamber. In one embodiment, the second advancing member pushes against the first advancing member to push the material out of the easing of a cartridge.

The two-part embodiment is particularly useful for applying caulk when the weather is cold. A user could have more than one type of material on hand in different cartridges to use with the dispensing apparatus.

### III. Alternate Embodiments

The invention may further exist in alternate embodiments. In one alternate embodiment, the material to be softened and the heating means are supplied separately. In this embodiment, it would be possible to use the same tube of adhesive more than one time by using a new heating means prior to each use.

In another alternate embodiment, the material to be applied is heated on demand. FIG. 7 is a design of this embodiment. In this embodiment, the second chamber (41) is located at the first end of the cartridge. The material to be softened (42) is located in the first chamber at the second end of the cartridge. The material to be softened is advanced toward the second chamber. As the material approaches the second chamber it melts/softens and flows out of the nozzle. In some embodiments, the interior of the first chamber is coated with a non-stick material such as silicone. This increases the ease with which the non-molten material advances through the first chamber. In one embodiment, the cartridge is configured such that a commercial caulk gun could be used to advance the material that needs to be melted/softened. In one embodiment, there is a plunger that is part of the cartridge that assists in pushing the material toward the second chamber.

In another alternate embodiment, the apparatus is configured to apply two or more materials simultaneously. In one example of this embodiment, the first material is a thermoplastic adhesive and the second material is a reactive adhesive. The first adhesive provides a temporary bond to hold the two substrates together until the second adhesive reaches its ultimate bond strength. In one embodiment the first adhesive is a hot melt adhesive. In one embodiment the second adhesive is selected from the group consisting of a reactive hot melt adhesive, a one-component heat activated adhesive and a two-component heat activated adhesive. The two materials can be applied with a variety of different nozzle configurations. In one embodiment, the materials are spiral sprayed so as to form an overlapping pattern.

In some embodiments, it would be helpful to have a color changing temperature sensor present on the outside of the dispenser to help the user judge when the adhesive is hot enough to apply. Further, in some embodiments, the material to be softened changes color when it reaches the appropriate application temperature. Additionally, while the above embodiments exemplify generally cylindrical cartridges, it should be understood that other shapes are possible, such as rectangular, triangular, etc.

In another aspect, the invention includes a method of dispensing a material comprising; providing a dispenser comprising at least one non-electric heat-generating component in heat transfer communication with the material, activating the said heat-generating component, allowing enough heat to be generated to render the material flowable and dispensing the material from the dispenser.

The inventors envision that the dispenser described herein can be used to apply material to a variety of surfaces, including but not limited to: paper, coated paper, paper laminates, cardboard, wood, wood composites, plastic parts, plastic films, plastic composites, metal, metal films, ceramics, fabric, beads, jewels, rocks, cement, cement composites, fiberglass, shingles, nylon, carbon fiber laminates, and metal extrusions.

The inventors envision that the dispenser described herein can be used to apply materials intended for various end uses. In one embodiment, the dispenser is used at remote construction sites where electricity is not easily accessible. In one embodiment, the dispenser may be used to do small home repairs or craft projects around the house.

The inventors also envision a particularly useful application of the dispenser described herein in the insulation area. The storage and transportation of materials such as liquid natural gas or ammonia, which are held at temperatures as low −260° F. in tanks and as they move through pipelines, requires a high level of insulation. The insulation is often a composite comprising more than one material. The insulating portion of the composite may be foamed and is often made from polyisocyanurate, polyurethane or cellular glass. To prevent condensation and the resulting loss in insulation efficiency a vapor barrier is often required. The vapor barrier covers the entire area of the exposed insulating portion. The vapor barrier often consists of an outer layer of either polyethylene sheeting or an aluminum laminate and an inner layer of adhesive. The adhesive serves to adhere the vapor barrier to the insulating portion. The vapor barrier adhesive is often an asphalt based pressure sensitive adhesive. Alternately, the vapor barrier may comprise a coating that is applied directly to the insulation material. The pipelines are often insulated in segments. The segments need to be adhered to the tank or pipe or joined and sealed to each other, often in remote locations where electricity is not readily available. It is envisioned in one embodiment, that the dispenser described herein may be used to apply a sealant or adhesive to seal or join sections of the insulating composite applied to the tank or along pipelines or to adhere the insulating portion to the tank or pipeline.

In one particular embodiment, the dispenser is used to apply a sealant or adhesive material to adhere segments of the insulating portion together to insulate a turning point in the pipe, or a protrusion in the tank or pipe.

As the insulating portion is often sealed with a vapor barrier, in some embodiments it is advantageous if the material used as a sealant or adhesive does not require the loss of volatile components or moisture to reach its final cured state.

### EXAMPLES

The scope of this invention encompasses any number of material and heating mechanism combinations.

To determine the amount and type of reactant for the exotherm, the mass of adhesive, as well as other key properties must be known. One method is to use Differential Scanning Calorimetry (DSC) to determine the enthalpy of fusion of the adhesive. ASTM E 793-01 can be used as a reference for this procedure. Once the ΔH_{Fusion} (usually expressed as J/gram) for the material is known, and the mass is determined, a minimum amount of energy to melt the adhesive is known.

To produce this energy, an exothermic reaction of the appropriate amount is used. The ΔH_{R×n} (usually expressed as kJ/mol) for the reaction is calculated, and scaled appropriately to release enough energy to melt the adhesive, taking into account design losses and requirements for adhesive to be above melting temperature.

Ex. ΔH_{Fusion} Adhesive 1=100 J/gram
Container holds 200 grams
Heat transfer efficiency is 25%

(200 grams*100 J/gram)/(25% efficiency)=80,000 J=80 kJ minimum

### Reaction 1=A+B=AB

ΔH_{R×n} reaction 1=−160 kJ/mol
Molecular weight reactant A=30 gr/mol
Molecular weight reactant B=42 gr/mol
½ of a mole is required, so 15 grams of reactant A, and 21 grams of reactant B are needed for the minimum amount of energy to melt the adhesive.

Other embodiments are within the claims.

What is claimed is:

1. A material dispenser comprising:
(a) a first chamber containing the material to be softened;
(b) a second chamber containing at least one heat-generating component, said second chamber adjacent to said first chamber;
(c) an application means in fluid communication with the first chamber, said means being configured to allow material to flow from the first chamber, through said means;
and optionally, a separate manually operable apparatus to aid in dispensing the heated material on demand.

2. The dispenser of claim 1 wherein said heat-generating component generates heat as a result of an exothermic chemical reaction.

3. The dispenser of claim 2 wherein said heat-generating component comprises iron.

4. The dispenser of claim 2 wherein said exothermic chemical reaction is initiated upon exposure to oxygen.

5. The dispenser of claim 1 wherein said second chamber contains a first compartment holding a first heat-generating component and a second compartment holding a second heat-generating component, the first and second compartments being separated in at least one area by a flexible barrier.

6. The dispenser of claim 5 wherein blending the first-heat generating component and the second heat generating component results in an exothermic chemical reaction.

7. The dispenser of claim 6 further comprising a movable reaction actuator.

8. The dispenser of claim 6 wherein the said second chamber is located within the material to be softened.

9. The dispenser of claim 6 wherein one heat-generating component comprises iron and the second heat-generating component comprises sodium chloride and water.

10. The dispenser of claim 9 wherein the material dispensed is a reactive hot melt adhesive.

11. The dispenser of claim 10 wherein the reactive hot melt adhesive has a viscosity of <about 10,000 cps at 149° C.

12. The dispenser of claim 1 wherein said heat-generating component generates heat as a result of a phase change.

13. The dispenser of claim 1 wherein said dispenser is disposable.

14. The dispenser of claim 1 wherein said first chamber and said second chamber are supplied separately and assembled just prior to use.

15. The dispenser of claim 1 wherein at least two different materials are dispensed simultaneously.

16. The dispenser of claim 1 wherein the material is heated on demand.

17. The dispenser of claim 1 wherein the material dispensed is selected from a group consisting of a hot melt adhesive, a reactive hot melt adhesive, and a two-component reactive adhesive.

18. The dispenser of claim 1 wherein the material dispensed is selected from a group consisting of a sealant and a caulk.

19. A method of dispensing a material comprising;
(a) providing a dispenser comprising at least one non-electric heat-generating component in heat transfer communication with the material
(b) activating the said heat-generating component
(c) allowing enough heat to be generated to render the material flow able;
(d) dispensing the material from the dispenser.

20. The method of claim 19 wherein at least two materials are dispensed simultaneously.

21. The method of claim 19 wherein the material dispensed is selected from a group consisting of an adhesive, a sealant and a caulk.

22. A method of dispensing a material comprising;
(a) providing a dispenser comprising at least one non-electric heat-generating component in heat transfer communication with the material
(b) activating the said heat-generating component
(c) allowing enough heat to be generated to render the material flowable;
(d) dispensing the material from the dispenser onto any portion of a pipeline, a storage tank or an insulation composite.
